(19) United States
(12) Patent Application Publication
(10) Pub. No.: US 2025/0142575 A1
(43) Pub. Date: May 1, 2025

(54) TECHNOLOGIES FOR SCHEDULING REQUESTS ACCOUNTING FOR UNUSED TRANSMISSION OCCASIONS

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 18/903,992

(22) Filed: Oct. 1, 2024

Related U.S. Application Data
(60) Provisional application No. 63/595,262, filed on Nov. 1, 2023.

(51) Int. Cl. H04W 72/21; H04W 28/02; H04W 72/1268; H04W 72/566

(52) U.S. Cl. CPC H04W 72/21; H04W 28/0263; H04W 72/1268; H04W 72/569

(57) ABSTRACT

The present application relates to devices and components, including apparatus, systems, and methods for scheduling requests with considerations of unused transmission occasions.

### CROSS-REFERENCE TO RELATED APPLICATION

This application claims the benefit of U.S. Provisional Patent Application No. 63/595,262, filed Nov. 1, 2023, the content of which is incorporated herein by reference in its entirety for all purposes.

### TECHNICAL FIELD

This application generally relates to cellular communication networks and, in particular, to technologies for scheduling requests accounting for unused transmission occasions.

### BACKGROUND

In a cellular wireless communication system, a base station configures uplink resources that may be used by a user equipment (UE) for transmitting uplink data. Efficient configuration and use of scheduled resources is desired.

### BRIEF DESCRIPTION OF THE DRAWINGS

FIG. 1 illustrates a network environment in accordance with some embodiments.

FIG. 2 illustrates a periodic traffic pattern in accordance with some embodiments.

FIG. 3 illustrates a configured grant allocation in accordance with some embodiments.

FIG. 4 illustrates extended reality packets in accordance with some embodiments.

FIG. 5 illustrates another configured grant allocation in accordance with some embodiments.

FIG. 6 illustrates another configured grant allocation in accordance with some embodiments.

FIG. 7 illustrates another configured grant allocation in accordance with some embodiments.

FIG. 8 illustrates an operational flow/algorithmic structure in accordance with some embodiments.

FIG. 9 illustrates another operational flow/algorithmic structure in accordance with some embodiments.

FIG. 10 illustrates another operational flow/algorithmic structure in accordance with some embodiments.

FIG. 11 illustrates a user equipment in accordance with some embodiments.

FIG. 12 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

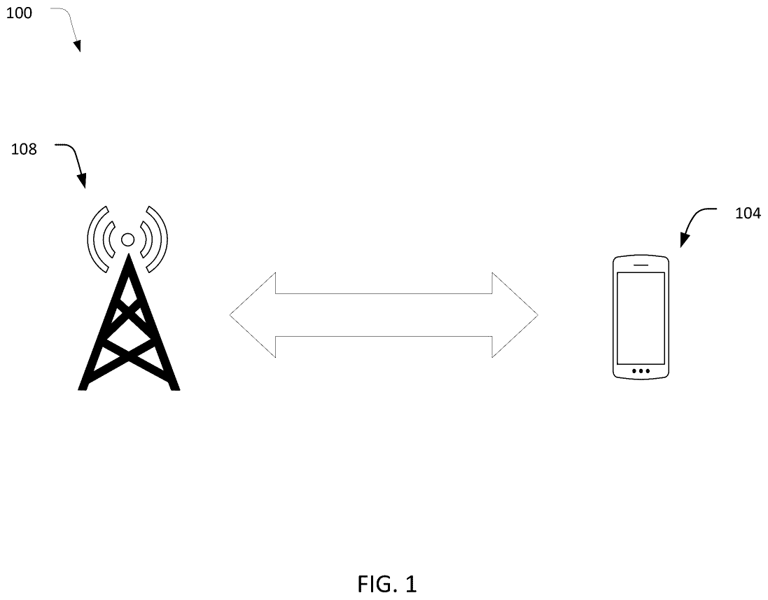

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The base station 108 may configure the UE 104 with parameters to be used to access resources of the RAN. Thereafter, the base station 108 may provide an indication of uplink/downlink resources that may be used by the UE 104 for transmitting/receiving data. In some instances, the data communicated in the network environment 100 may be associated with periodic traffic patterns. For example, payloads are typically periodical for both downlink and uplink of extended reality (XR) services. This may occur for transmission of video data, which may be associated with a frame rate of 60, 90, or 120 frames per second, for example.

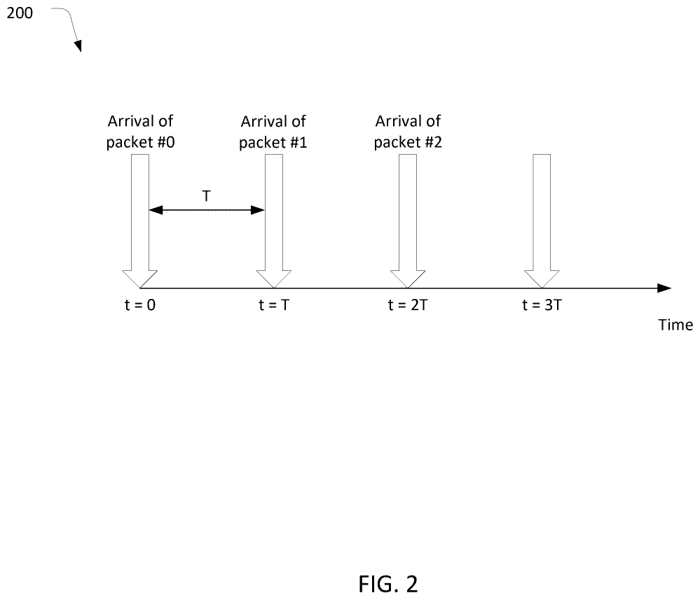

FIG. 2 illustrates a periodic traffic pattern 200 in accordance with some embodiments. The periodic traffic pattern may include video data for XR services or some other periodic traffic. The periodic traffic pattern 200 illustrates a packet arrival rate of 1/T. For example, packet #0 is received at t=0, packet #1 is received at t=T, packet #2 is received at t=2T, packet #3 is received at t=3T, etc.

If the base station 108 obtains assistance information relating to characteristics of the periodic traffic, it may utilize such information to perform efficient resource allocation. For example, due to the periodic nature of XR services, the base station 108 may use a configured grant as a resource allocation method for uplink XR traffic. The base station 108 may use radio resource control (RRC) signaling to provide the UE 104 with the configured grant. The configured grant may indicate reoccurring resources that may be used for physical downlink shared channel (PDSCH) or physical uplink shared channel (PUSCH) transmissions without relying on the base station 108 to transmit downlink control information (DCI) to signal each resource allocation.

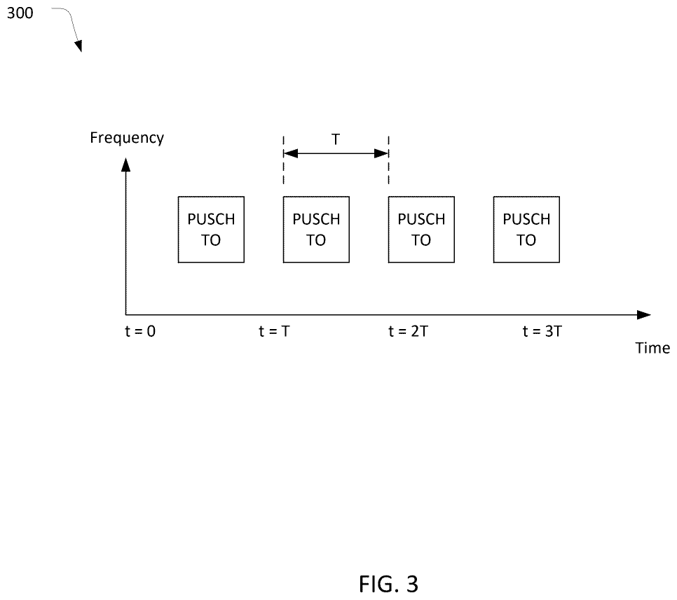

FIG. 3 illustrates a configured grant allocation 300 in accordance with some embodiments. The configured grant allocation 300 pre-configures periodic uplink radio resources, for example, PUSCH transmission occasions (TOs), for the UE 104. Thus, the UE 104 will know, in advance, the time-frequency resources that may be used for PUSCH transmissions without the need for dynamic (for example, DCI) signaling of the resource allocations. The configured grant allocation 300 as shown with the periodicity equal to T.

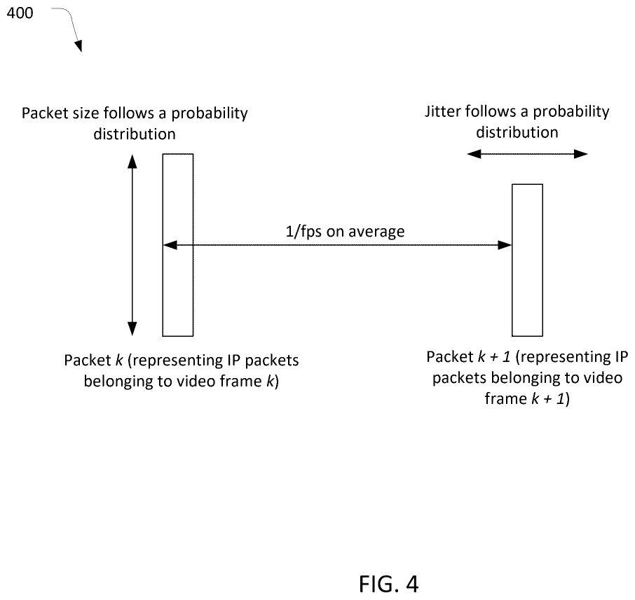

Periodic traffic that supports XR services may be associated with a random jitter in which an actual packet arrival time may be offset from a nominal timing (based on traffic periodicity). Further, the packet size may also vary over time. FIG. 4 illustrates XR packets 400 that illustrate the jitter and packet size variance in accordance with some embodiments. Packet k represents Internet protocol (IP) packets that belong to a video frame k, and packet k+1 represents IP packets that belong to a video frame k+1. While, on average, adjacent packets are received 1/frame per second (fps), arrival of a specific packet, for example, packet k+1 may be associated with jitter that follows a probability distribution. Similarly, sizes of the packets may also follow a probability distribution. Thus, configured scheduling such as configured grant may be enhanced to accommodate such traffic characteristics in the uplink.

When a packet size is larger than a fixed transport block size (TBS) of a configured grant (CG) occasion, the packet may not be accommodated within one CG cycle. This may cause latency. Conversely, when a packet size is smaller than the fixed TBS of a CG occasion, some resources may be unused, which may lead to inefficient resource utilization as the base station 108 could allocate the resource to other UEs.

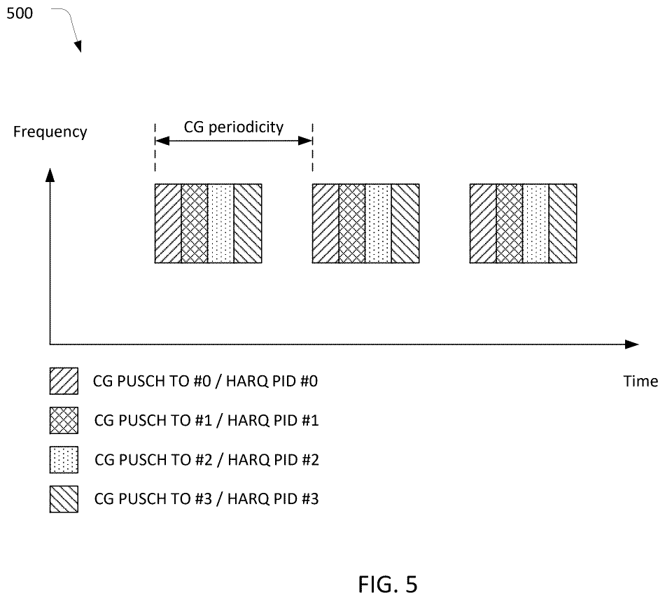

FIG. 5 illustrates an exemplary configured grant allocation 500 in accordance with some embodiments. The configured grant allocation 500 may be used for traffic with varying packet sizes such as audio or video traffic. The configured grant allocation 500 may include a plurality of CG PUSCH TOs in each CG cycle. For example, as shown, each CG cycle may include four CG PUSCH TOs, CG PUSCH TO #0, CG PUSCH TO #1, CG PUSCH TO #2, and CG PUSCH TO #3. If a large packet size is to be transmitted, the UE 104 may use more than one or even all of the CG PUSCH TOs of a given CG cycle. If a small packet size is to be transmitted, the UE 104 may only use one or a subset of the CG PUSCH TOs.

The configured grant allocation 500 may be associated with a hybrid automatic repeat request (HARQ) process. A HARQ procedure may provide reliable communication by combining error correction and retransmission, in which the UE 104 stores a transmitted MAC PDA in a HARQ buffer of a corresponding HARQ process. For example, each CG PUSCH TO may be associated with a respective HARQ process identifier (PID). If an UL transmission of a CG PUSCH TO is not received by the BS 108, e.g., not successfully decoded, the BS 108 may request a retransmission by sending the UE a retransmission request with an indication of the HARQ PID that corresponds to the CG PUSCH TO. Then, the UE 104 may fetch the MAC PDU stored in the HARQ buffer of the corresponding HARQ process for retransmission. In some embodiments, the CG PUSCH TOs in different CG cycles/periods do not have the same set of HARQ PIDS.

A CG timer may be used with respect to the HARQ process. For example, after an uplink transmission at a CG PUSCH TO or a dynamic grant (DG) PUSCH TO, the UE 104 may start a CG timer that is associated with a HARQ PID of the CG/DG PUSCH TO. The UE 104 may monitor a physical downlink control channel (PDCCH) for a retransmission request while the CG timer is running. When the CG timer associated with a HARQ PID is running, the UE 104 may not use the CG PUSCH TO with this HARQ PID for a new uplink transmission or an initial uplink transmission. After the CG timer associated with the HARQ PID expires, the UE 104 may clear or flush the HARQ buffer of this HARQ PID, and use the subsequent CG PUSCH TOs with the HARQ PID for a new transmission or an initial transmission.

As noted above, due to the varying packet size of periodic traffic, for example, XR traffic, the UE 104 may not need to use every single PUSCH TO within a CG cycle. Therefore, the UE 104 may send an indication to inform the base station 108 of subsequent PUSCH TOs that are not to be used. The base station 108 may then re-allocate the resources to other UEs. The indication may be transmitted in uplink control information (UCI) referred to as unused transmission occasion (UTO) UCI. The UTO UCI may be multiplexed into a PUSCH transmission, similar to CG-UCI. In some embodiments, the UTO UCI may be included in every CG PUSCH that is transmitted.

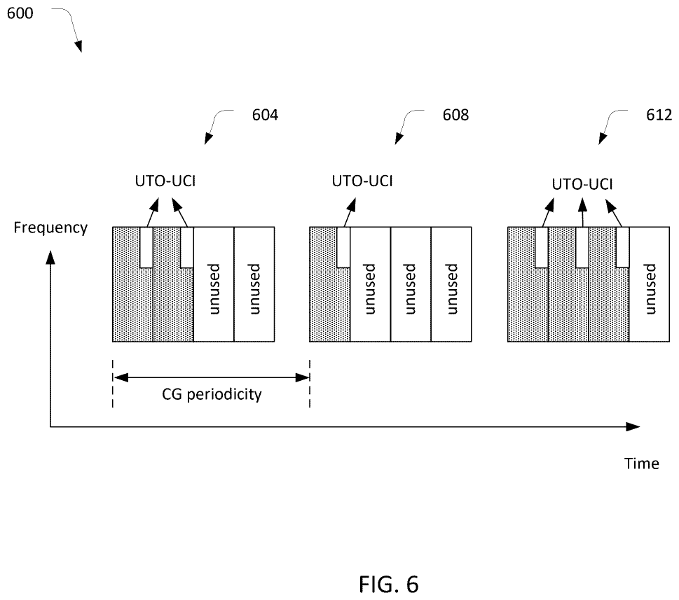

FIG. 6 illustrates a configured grant allocation 600 in accordance with some embodiments. The configured grant allocation 600 may include three CG cycles, CG cycle 604, CG cycle 608, and CG cycle 612. Each cycle may include four CG PUSCH TOs, similar to configured grant allocation 500. Each CG PUSCH TO having a PUSCH transmission is shown with cross-hatching. For example, CG cycle 604 is shown with PUSCH transmissions in the first two CG PUSCH TOs, CG cycle 608 is shown with a PUSCH transmission in a first CG PUSCH TO, and cycle 612 is shown with PUSCH transmission in the first three CG PUSCH TOs.

A UTO UCI may be multiplexed into each PUSCH transmission. In some embodiments, each UTO UCI may include a bitmap with x values that correspond to x CG PUSCH TOs that follow a particular UTO UCI. A value of ‘0’ may indicate the corresponding CG PUSCH TO will have a PUSCH transmission, while a value of ‘1’ may indicate the corresponding CG PUSCH TO will not be used by the UE 104 for a PUSCH transmission (for example, the CG PUSCH TO is indicated to be unused). A UTO UCI may cover CG PUSCH TOs within one or more CG cycles. For example, if the UTO UCI in the PUSCH transmission of the first CG PUSCH TO of CG cycle 604 has a six-bit bitmap, it may be ‘011011’ to indicate the second CG PUSCH TO of CG cycle 604 and the first CG PUSCH TO of CG cycle 608 will be used for PUSCH transmissions and the third and fourth CG PUSCH TOs of CG cycle 604 and the last three CG PUSCH TOs of CG cycle 608 will not be used by the UE 104 for PUSCH transmissions.

As the data buffer size may only be visible to a media access control (MAC) layer of the UE 104, the MAC layer may generate the information to be conveyed by a UTO UCI and provide the information to a physical (PHY) layer of the UE 104. The PHY layer may then multiplex the UTO UCI onto the PUSCH transmission. The MAC entity may not process any CG PUSCH TO indicated as “unused” in UTO-UCI for a MAC protocol data unit (PDU) generation. In some embodiments, the MAC entity does not deliver the uplink grants corresponding to CG PUSCH TO indicated as “unused” to the HARQ entity. Thus, no PUSCH transmission will be performed on these unused uplink-shared channel (UL-SCH) resources.

If the UE 104 needs UL-SCH resources that are not otherwise available, the UE 104 may transmit a scheduling request (SR) on physical uplink control channel (PUCCH) to request such resources. An SR framework of existing cellular networks is described in section 5.4.4 of 3GPP TS 38.321 v17.6.0 (2023-09). TS 38.321 defines procedures that allow a UE to prioritize an SR transmission, which allows for signaling of the SR, when PUCCH resources for the SR transmission (referred to as SR-PUCCH resource) overlaps with another uplink/sidelink (SL) transmission resource (for example, UL-SCH/SL-SCH). In particular, TS 38.321 provides that a UE should not prioritize/transmit an SR if its PUCCH overlaps with a UL-SCH resource and simultaneous PUSCH-PUCCH transmissions are not enabled/allowed on a corresponding MAC entity: “2> if the PUCCH resource for the SR transmission occasion does not overlap with a measurement gap: 3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCHSecondaryPUCCHgroup or simultaneousSR-PUSCH-diffPUCCH-Groups nor an SL-SCH resource; or . . . 4> consider the SR transmission as a prioritized SR transmission . . . 3> else: 4> consider the SR transmission as a de-prioritized SR transmission.”

In some instances, this overlapping UL-SCH may be a CG PUSCH that has already been indicated as “unused” according to the UTO-UCI mechanism described above. In this case, there is no need to de-prioritize the SR transmission, because the overlapping UL-SCH resource cannot be transmitted anyway. Thus, embodiments describe how to avoid unnecessary deprioritization of an SR when its PUCCH overlaps with an UL-SCH resource that has already been indicated/identified as unused and simultaneous PUCCH-PUSCH transmission is not allowed.

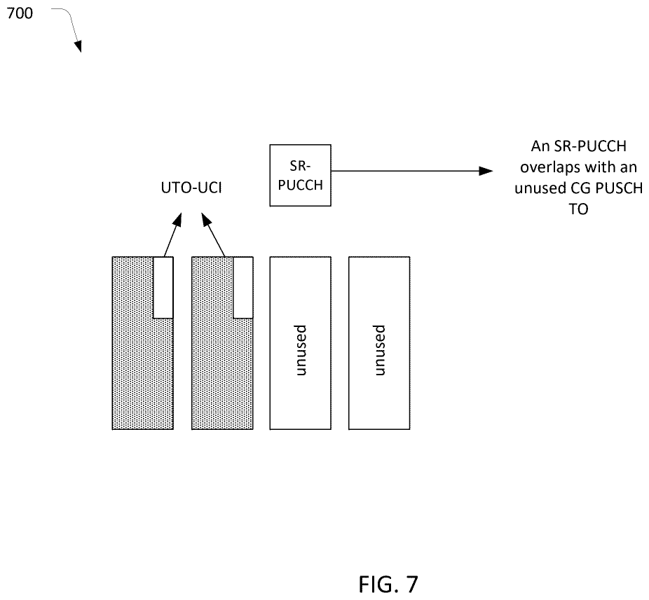

FIG. 7 illustrates a configured grant allocation 700 in accordance with some embodiments. In the configured grant allocation 700, PUSCH transmissions are to be transmitted in the first two CG PUSCH TOs, and the last two CG PUSCH TOs are unused by the UE 104, as indicated in UTO-UCI multiplexed in the PUSCH transmissions. The UE 104 may also have an SR-PUCCH that overlaps with an unused CG PUSCH TO.

Given the current prioritization mechanism described above, the SR-PUCCH would be deprioritized even though the CG PUSCH TO is unused. However, embodiments of the present disclosure enable prioritization of the SR-PUCCH and, therefore, transmission of the SR in these scenarios.

In some embodiments, when determining whether a SR-PUCCH can be prioritized over an overlapping UL-SCH resource, and simultaneous transmission of SR is not allowed on the MAC entity, the UE 104 may determine prioritization based on the following rules. If the overlapping UL-SCH resource corresponds to an uplink grant (for example, configured grant) that has not been indicated/identified by a MAC entity as to be unused for PUSCH transmission (for example, has not been indicated to lower layer, and/or not indicated as an UTO in UTO-UCI sent to gNB): the UE 104 may deprioritize the SR transmission; else, if the overlapping UL-SCH resource corresponds to an uplink grant (for example, configured grant) that has been indicated/identified by the MAC entity as to be unused for PUSCH transmission (for example, has been indicated to lower layer, and/or indicated as a TO in UTO-UCI sent to gNB): the UE 104 may prioritize the SR transmission as long as other conditions for prioritizing the SR transmission (if required) are also fulfilled.

In some embodiments, any UL-SCH resource corresponding to an uplink grant (for example, configured grant) that has been indicated/identified by a MAC entity as to be unused for PUSCH transmission may be considered as an unavailable UL-SCH resource, and a general rule may be defined such that the UE 104 may ignore (or does not consider) any unavailable UL-SCH resource that overlaps with an SR-PUCCH when determining if the SR can be prioritized. For example, this may be implemented by adding the underlined portion to “NOTE 2” in Clause 5.4.5 of 3GPP TS 38.321 (and several other parts in the specification) “UL-SCH resources are considered available if the MAC entity has been configured with, receives, or determines an uplink grant is to be used. If the MAC entity has determined at a given point in time that UL-SCH resources are available, this need not imply that UL-SCH resources are available for use at that point in time.”

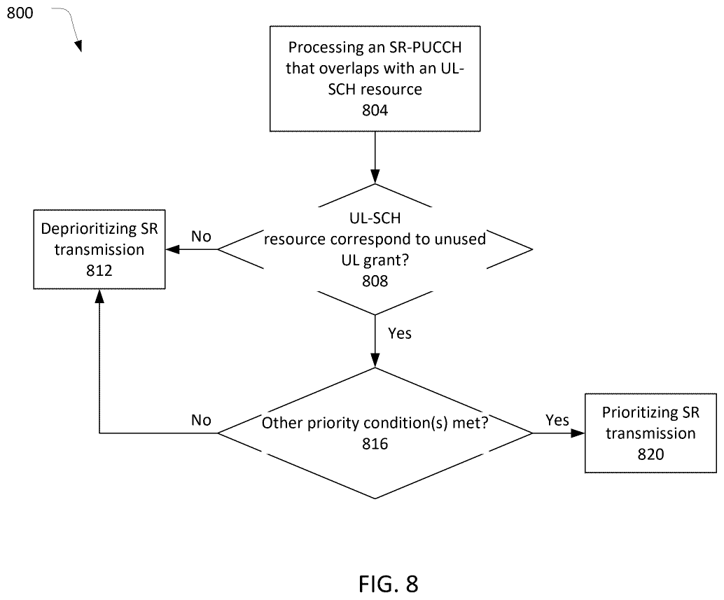

FIG. 8 illustrates an operation flow/algorithmic structure 800 in accordance with some embodiments. The operation flow/algorithmic structure 800 may be performed or implemented by the UE 104, the UE 1100, or components thereof, for example, processors 1004.

The operation flow/algorithmic structure 800 may include, at 804, processing an SR-PUCCH that overlaps with an UL-SCH resource. The UL-SCH resource may be a CG PUSCH TO as described elsewhere herein. In some embodiments, the UL-SCH resource may be one in which a simultaneous transmission with SR is not allowed by a simultaneous transmission configuration that may be provided to the UE 104 from the base station 108 using RRC signaling.

A simultaneous transmission configuration may be, for example, a simultaneousPUCCH-PUSCH configuration that enables simultaneous PUCCH and PUSCH transmissions with different priorities for a primary PUCCH group, a simultaneousPUCCH-PUSCHSecondaryPUCCHgroup configuration that enables simultaneous PUCCH and PUSCH transmissions with different priorities for a secondary PUCCH group, or a simultaneousSR-PUSCH-diffPUCCH-Groups configuration that enables simultaneous SR and PUSCH transmissions in different PUCCH groups.

The operation flow/algorithmic structure 800 may further include, at 808, determining whether the UL-resource corresponds to an unused UL grant. In some embodiments, this determination may be based on whether a UTO-UCI was (or is to be) sent to the base station 108. It may be noted that, in some instances, the determination of whether the UL grant is unused at 808 may be distinct from the generation/transmission of the UTO-UCI. For example, the determination at 808 may be used for a basis for generating/transmitting the UTO-UCI as well as a basis for the prioritization/deprioritization of the SR transmission described as follows.

In some embodiments, the UE 104 may determine whether the UL-SCH resource corresponds to an unused UL grant based on whether a CG timer associated with a HARQ PID of the overlapping UL-SCH resource is running when the PUSCH of this UL-SCH resource is to be processed/transmitted. If the CG timer is running, a PUSCH transmission cannot be transmitted in the UL-SCH resource as its HARQ PID is not yet available.

If it is determined that the UL-SCH resource does not correspond to an unused UL grant (for example, the UL-SCH resource is to be used by the UE 104 for a PUSCH transmission), the operation flow/algorithmic structure 800 may advance to deprioritizing the SR transmission that is to be sent on the SR-PUCCH. By deprioritizing the SR transmission, the UE may refrain from transmitting the SR transmission in the overlapped SR-PUCCH and may identify a later uplink resource to be used.

If it is determined that the UL-SCH resource corresponds to an unused UL grant (for example, the UL-SCH resource is not to be used by the UE 104 for a PUSCH transmission), the operation flow/algorithmic structure 800 may advance to determining whether other priority conditions are met at 816. The other priority conditions may include one or more of the following.

In some embodiments, the other priority conditions may be based on a triggering logical channel (LCH) or logical channel group (LCG). The triggering LCH/LCG may be the LCH/LCG associated with the data that triggers the SR (for example, the data that is to be transmitted in a resource allocated based on the SR). This may be based on, for example, an identifier (ID) of the triggering LCH/LCG. For example, one or more specific LCH/LCG IDS may be designated as being associated with a higher priority. In some embodiments, the other priority condition may be satisfied if a priority of the triggering LCH/LCG is higher than a predetermined priority threshold; if a data volume of the triggering LCH/LCG is greater than a predetermined volume threshold; or if a remaining time (for example, a minimum/maximum/average remaining time) until a discarding of the data in the triggering LCH/LCG is less than a predetermined time threshold.

In some embodiments, the other priority conditions may be based on a type of MAC control element (CE) that triggers an SR. For example, the UE 104 may determine the other priority condition is satisfied if an SR is triggered by a specific type of MAC CE such as, for example, a beam failure recovery (BFR) MAC CE.

In some embodiments, the other priority conditions may be based on a PUCCH configuration of the SR. For example, the UE 104 may determine whether the other priority condition is satisfied based on whether an SR-PUCCH configuration ID, format, etc. is associated with a priority higher than a predetermined threshold priority.

In some embodiments, the additional priority condition may be based on an SR configuration parameter. For example, the UE 104 may determine the other priority condition is satisfied based on whether an SR configuration ID, SR prohibit timer value, or instantaneous value of SR counter, etc. is associated with a priority higher than a predetermined threshold priority.

In some embodiments, the additional priority condition may be based on a quality of service (QOS) flow mapped to data radio bearer (DRB) associated with the triggering LCH/LCG. For example, the UE 104 may determine the other priority condition is satisfied if the QoS flow is associated with a priority higher than a predetermined threshold priority.

If it is determined, at 816, that the other priority conditions are met, the operation flow/algorithmic structure 800 may advance to prioritizing the SR transmission that is to be sent on the SR-PUCCH. By prioritizing the SR transmission, the UE 104 may transmit the SR transmission in the overlapped SR-PUCCH resource.

If it is determined, at 816, that the other priority conditions are not met, the operation flow/algorithmic structure 800 may advance to deprioritizing the SR transmission that is to be sent on the SR-PUCCH at 812. Thus, in these embodiments, even if the overlapping UL-SCH resource has been indicated/identified as unused at 808, the UE 104 may still deprioritize the SR transmission if it is determined that the other priority conditions are not satisfied at 816.

In some embodiments, no additional priority conditions may be considered and, if it is determined that the UL-SCH resource corresponds to an unused UL grant at 808, the operation flow/algorithmic structure may directly advance to prioritizing the SR transmission at 820.

In some instances, the behavior of the UE 104 relating to SR (de) prioritization as described herein may be pre-configured, for example, by RRC messages, or fixed in a specification, for example, in 3GPP TS 38.321. For example, the specific other priority conditions that are to be considered at 816 (along with relevant thresholds, if any) may be pre-configured, for example, by RRC messages, or fixed in a specification, for example, in 3GPP TS 38.321. For instance, the UE 104 may be configured to apply the behaviors of such SR (de) prioritization only when the SR corresponds to particular SR configuration(s). The enablement of such behaviors may be configured per SR configuration.

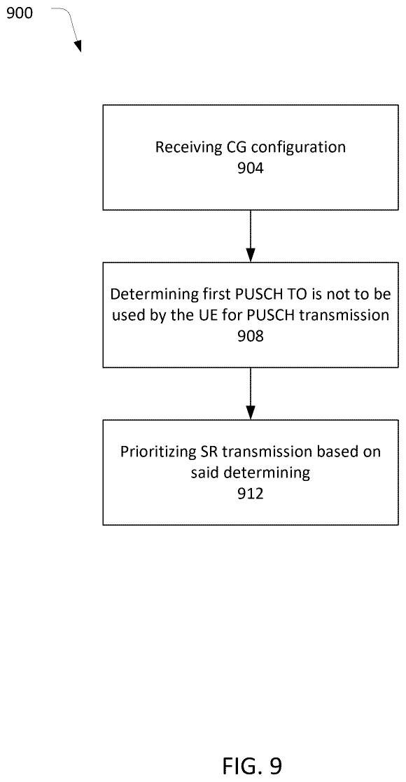

FIG. 9 illustrates an operation flow/algorithmic structure 900 in accordance with some embodiments. The operation flow/algorithmic structure 900 may be performed or implemented by the UE 104, the UE 1100, or components thereof, for example, processors 1004.

The operation flow/algorithmic structure 900 may include, at 904, receiving a CG configuration. The CG configuration may configure a plurality of PUSCH transmission occasions in each CG cycle. Each PUSCH transmission occasion may be associated with a respective HARQ PID.

The operation flow/algorithmic structure 900 may further include, at 908, determining a first PUSCH TO is not to be used by the UE 104 for a PUSCH transmission. In some embodiments, the UE 104 may generate and transmit a UTO UCI to indicate, to the base station 108, that the first PUSCH TO is not to be used by the UE 104 for a PUSCH transmission. The UTO UCI may be transmitted in a second PUSCH TO that occurs prior to the first PUSCH TO.

In some embodiments the UE 104 may determine the first PUSCH TO is not to be used by the UE 104 for a PUSCH transmission based on a CG timer. For example, the UE 104 may determine the first PUSCH TO, which may be overlapped with an SR-PUCCH resource, is not available for a PUSCH transmission if a CG timer associated with the HARQ PID of the first PUSCH TO is still running when the overlapped SR-PUCCH resource occurs.

The operation flow/algorithmic structure 900 may further include, at 912, prioritizing an SR transmission based on said determining that the first PUSCH TO is not to be used by the UE 104 for a PUSCH transmission. Based on the prioritization of the SR transmission, the UE 104 may transmit the SR transmission to the base station 108.

In some embodiments, the determining that the first PUSCH TO is not to be used by the UE for a PUSCH transmission is done by a MAC entity of the UE 104. The MAC entity may then prioritize the SR transmission based on the indication. The MAC entity may provide an indication that the first PUSCH TO is not to be used by the UE or that the SR is to be prioritized to a PHY entity of the UE 104.

In some embodiments, the prioritization of the SR transmission may be based further on the UE 104 detecting a priority condition associated with the SR transmission. The priority condition may be a triggering LCH/LCG being associated with a priority greater than a predetermined threshold priority; a data volume of the triggering LCH/LCG being greater than a predetermined threshold volume; a remaining time until discarding of the data of the triggering LCH/LCG being less than a predetermined time threshold; or a QoS flow mapped to a DRB associated with the LCH/LCG being associated with a priority greater than a predetermined threshold priority.

In some embodiments, the priority condition may be based on a type of MAC CE that triggers the SR transmission, a configuration of the SR PUCCH, or SR configuration parameters.

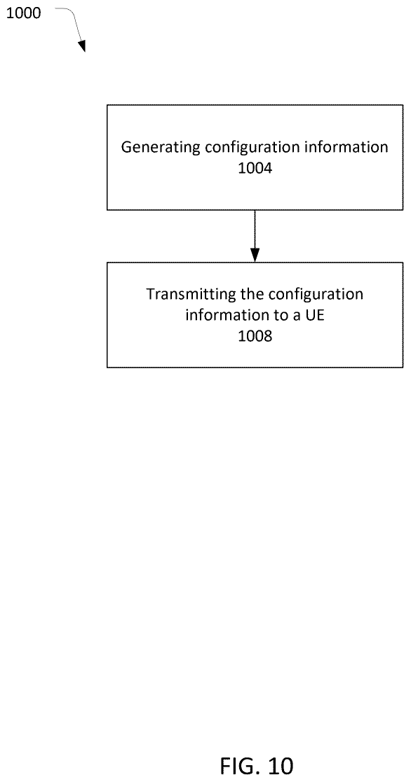

FIG. 10 illustrates an operation flow/algorithmic structure 1000 in accordance with some embodiments. The operation flow/algorithmic structure 1000 may be performed or implemented by the base station 108, the base station 1200, or components thereof, for example, processors 1204.

The operation flow/algorithmic structure 1000 may include, at 1004, generating configuration information. The configuration information may include a CG configuration that configures a plurality of CG PUSCH TOs per cycle. The configuration information may additionally/alternatively include an SR configuration that configures parameters associated with SR transmissions. In some embodiments, the SR configuration may include an indication of whether a UE is to perform an SR (de) prioritization operation as described with respect to operation flows/algorithmic structures 800 or 900 or as described elsewhere herein. For example, the indication may indicate whether the UE is to determine whether a CG PUSCH resource is to be used prior to deprioritizing an SR transmission of an SR PUCCH that overlaps the CG PUSCH resource in a time domain.

The operation flow/algorithmic structure 1000 may further include, at 1004, transmitting the SR configuration to a UE.

In some embodiments, in order to accommodate the (de) prioritization of scheduling requests accounting for unused uplink grants, the text of 3GPP TS 38.321 may be updated with the underlined passages as follows:
2> if the PUCCH resource for the SR transmission occasion does not overlap with a measurement gap:
   3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCHSecondaryPUCCHgroup or simultaneousSR-PUSCH-diffPUCCH-Groups that has not been indicated or identified as unused for PUSCH transmission nor an SL-SCH resource; or
   . . .
      4> consider the SR transmission as a prioritized SR transmission.
   . . .
   3> else:
      4> consider the SR transmission as a de-prioritized SR transmission.

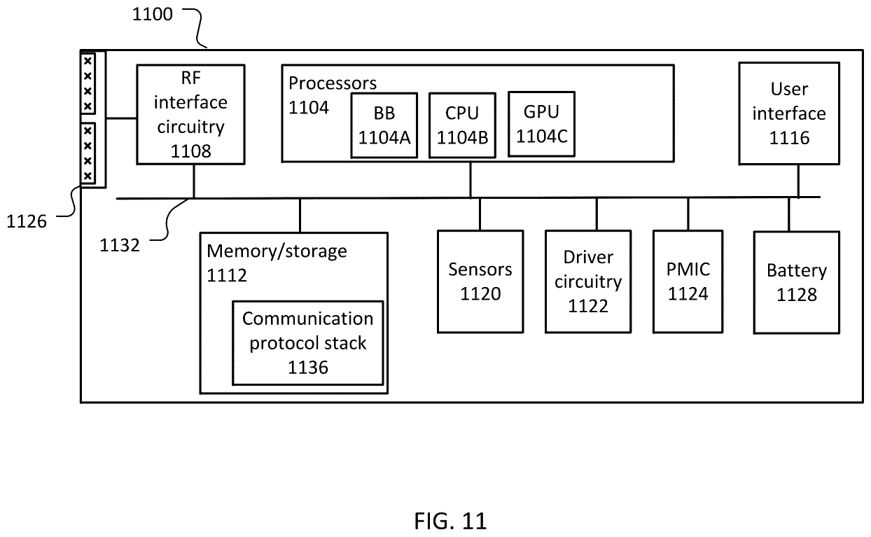

FIG. 11 illustrates a UE 1100 in accordance with some embodiments. The UE 1100 may be similar to and substantially interchangeable with UE 114 of FIG. 1.

The UE 1100 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1100 may include processors 1104, RF interface circuitry 1108, memory/storage 1112, user interface 1116, sensors 1120, driver circuitry 1122, power management integrated circuit (PMIC) 1124, antenna structure 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangements of the components shown may occur in other implementations.

The components of the UE 1100 may be coupled with various other components over one or more interconnects 1132, which may represent any type of interface circuitry, input/output, bus (local, system, or expansion), transmission line, trace, or optical connection to enable communication by allowing various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry, or processor circuitry that executes or otherwise operates computer-executable instructions, such as program code, software modules, or functional processes from memory/storage 1112 to cause the UE 1100 to perform operations as described herein.

The processors 1104 may perform operations associated with determining whether an UL grant is to be used and prioritizing an SR transmission accordingly as describe herein. For example, the processors 1104 may perform the operation flow/algorithmic structure 800, 900, or some other operation described herein.

In some embodiments, the baseband processor circuitry 1104A may access a communication protocol stack 1136 in the memory/storage 1112 to communicate over a 3GPP-compatible network. In general, the baseband processor circuitry 1104A may access the communication protocol stack 1136 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1112 may include one or more non-transitory, computer-readable media that includes instructions (for example, the communication protocol stack 1136) that may be executed by one or more of the processors 1104 to cause the UE 1100 to perform various operations described herein. The memory/storage 1112 includes any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1126 and proceed to filter and amplify (with a low-noise amplifier) the signal. The signal may be provided to a receiver of the transceiver that down-converts the RF signal into a baseband signal that is provided to the baseband processor of the processor 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1126.

In various embodiments, the RF interface circuitry 1108 may be configured to transmit/receive signals in a manner compatible with NR access technologies.

The antenna structure 1126 may include antenna elements to convert electrical signals into radio waves to travel through the air and to convert received radio waves into electrical signals. The antenna elements may be arranged into one or more antenna panels. The antenna structure 1126 may have antenna panels that are omnidirectional, directional, or a combination thereof to enable beamforming and multiple input, multiple output communications. The antenna structure 1126 may include microstrip antennas, printed antennas fabricated on the surface of one or more printed circuit boards, patch antennas, or phased array antennas. The antenna structure 1126 may have one or more panels designed for specific frequency bands, including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various I/O devices that may be present within or connected to the UE 1100. For example, the driver circuitry 1122 may include circuitry to facilitate the coupling of a universal integrated circuit card (UICC) or a universal subscriber identity module (USIM) to the UE 1100. For additional examples, driver circuitry 1122 may include a display driver to control and allow access to a display device, a touchscreen driver to control and allow access to a touchscreen interface, sensor drivers to obtain sensor readings of sensors 1120 and control and allow access to sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage the power provided to various components of the UE 1100. In particular, with respect to the processors 1104, the PMIC 1124 may control power-source selection, voltage scaling, battery charging, or DC-to-DC conversion.

In some embodiments, the PMIC 1124 may control or otherwise be part of various power-saving mechanisms of the UE 1100, including DRX, as discussed herein.

A battery 1128 may power the UE 1100, although in some examples, the UE 1100 may be mounted and deployed in a fixed location and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

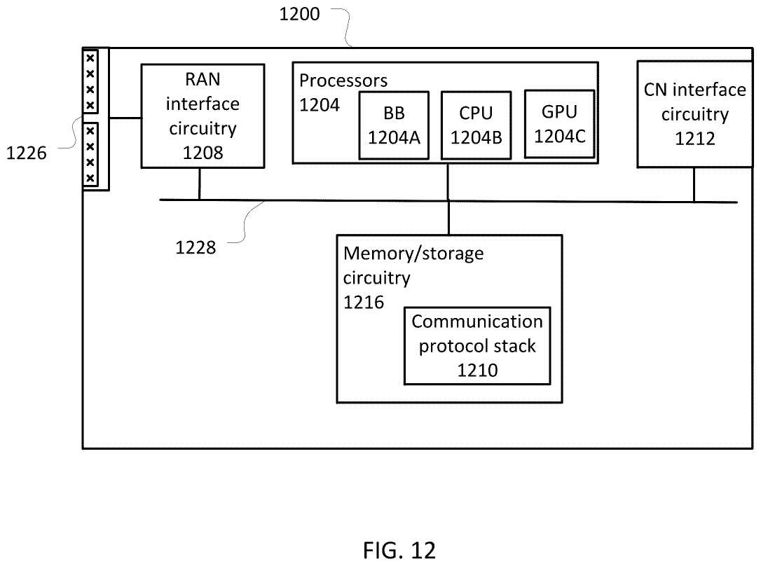

FIG. 12 illustrates a base station 1200 in accordance with some embodiments. The base station 1200 may be similar to and substantially interchangeable with base station 108, a device implementing one of the network hops 124, an IAB node, a network-controlled repeater, or a server in a core network or external data network.

The base station 1200 may include processors 1204, RF interface circuitry 1208 (if implemented as an access node), core network (CN) interface circuitry 1212, memory/storage circuitry 1216, and antenna structure 1226.

The processors 1204 may perform operations associated with configuring a UE with SR/CG configurations. The SR configuration may include an indication of whether a UE is to determine whether an UL grant is to be used prior to (de) prioritizing an SR transmission of an overlapped SR-PUCCH resource as described herein. For example, the processors 1204 may perform the operation flow/algorithmic structure 1000 or some other operation described herein.

The components of the base station 1200 may be coupled with various other components over one or more interconnects 1228.

The processors 1204, RF interface circuitry 1208, memory/storage circuitry 1216 (including communication protocol stack 1210), antenna structure 1226, and interconnects 1228 may be similar to like-named elements shown and described with respect to FIG. 11.

The CN interface circuitry 1212 may provide connectivity to a core network, for example, a 5th Generation Core network (5GC) using a 5GC-compatible network interface protocol such as carrier Ethernet protocols, or some other suitable protocol. Network connectivity may be provided to/from the base station 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

In some embodiments, the base station 1200 may be coupled with transmit receive points (TRPs) using the antenna structure 1226, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary aspects are provided.

Example 1 includes a method to be implemented by a user equipment (UE), the method comprising: processing a scheduling request-physical uplink control channel (SR-PUCCH) resource that overlaps with an uplink (UL)-shared channel (SCH) resource; determining whether the UL-SCH resource corresponds to an unused UL grant; and determining, based on said determining whether the UL-SCH resource corresponds to an unused UL grant, whether to prioritize a scheduling request (SR) transmission in the SR-PUCCH resource.

Example 2 includes the method of example 1 or some other example herein, wherein: determining whether the UL-SCH resource corresponds to an unused UL grant includes determining the UL-SCH resource corresponds to an unused UL grant; and determining whether to prioritize a SR transmission includes prioritizing the SR transmission based on said determining the UL-SCH resource corresponds to the unused UL grant.

Example 3 includes the method of example 2 or some other example herein, further comprising: determining that a priority condition is met; and prioritizing the SR transmission based further on said determining that the priority condition is met.

Example 4 includes the method of example 3 or some other example herein, wherein data of a logical channel (LCH) or logical channel group (LCG) triggers the SR transmission and the priority condition comprises: the LCH or LCG being associated with a priority greater than a predetermined threshold priority; or a data volume of the LCH or LCG being greater than a predetermined threshold volume.

Example 4 includes the method of example 3 or some other example herein, wherein data of a logical channel (LCH) or logical channel group (LCG) triggers the SR transmission and the priority condition comprises: a remaining time until discarding of the data of the LCH or LCG is less than a predetermined time threshold; or quality of service flow mapped to a data radio bearer associated with the LCH/LCG being associated with a priority greater than a predetermined threshold priority.

Example 6 includes the method of example 3 or some other example herein, wherein the priority condition is based on: a type of media access control (MAC) control element (CE) that triggers the SR transmission; a physical uplink control channel (PUCCH) configuration associated with the SR transmission; or SR configuration parameters.

Example 7 includes the method of example 1 or some other example herein, wherein: determining whether the UL-SCH resource corresponds to an unused UL grant includes determining the UL-SCH resource does not correspond to an unused UL grant; and determining whether to prioritize a SR transmission includes deprioritizing the SR transmission based on said determining the UL-SCH resource does not correspond to the unused UL grant.

Example 8 includes the method of example 1 or some other example herein, wherein the UL-SCH resource corresponds to a first PUSCH transmission occasion associated with a hybrid automatic repeat request (HARQ) process identifier (PID) and the method further comprises: determining a CG timer associated with the HARQ PID is running; and determining, based on said determining the CG timer is running, the UL-SCH resource corresponds to an unused UL grant.

Example 9 includes a method to be implemented by a user equipment (UE), the method comprising: receiving a configured grant (CG) configuration that configures a plurality of physical uplink shared channel (PUSCH) transmission occasions; determining a first PUSCH transmission occasion of the plurality of PUSCH transmission occasions is not to be used by the UE for a PUSCH transmission; and prioritizing, based on said determining the first PUSCH transmission occasion is not to be used by the UE for a PUSCH transmission, a scheduling request (SR) transmission in an SR transmission occasion that overlaps with the first PUSCH transmission occasion.

Example 10 includes the method of example 9 or some other example herein, further comprising: transmitting, based on said determining the first PUSCH transmission occasion is not to be used by the UE for a PUSCH transmission, an unused transmission occasion (UTO) uplink control information (UCI) in a second PUSCH transmission occasion of the plurality of PUSCH transmission occasions.

Example 11 includes the method of example 9 or some other example herein, further comprising: detecting a priority condition associated with the SR transmission; and prioritizing the SR transmission based further on said detecting the priority condition.

Example 12 includes the method of example 11 or some other example herein, wherein data of a logical channel (LCH) or logical channel group (LCG) triggers the SR transmission and the priority condition comprises: the LCH or LCG being associated with a priority greater than a predetermined threshold priority; or a data volume of the LCH or LCG being greater than a predetermined threshold volume.

Example 13 includes the method of example 11 or some other example herein, wherein data of a logical channel (LCH) or logical channel group (LCG) triggers the SR transmission and the priority condition comprises: a remaining time until discarding of the data of the LCH or LCG is less than a predetermined time threshold; or quality of service flow mapped to a data radio bearer associated with the LCH/LCG being associated with a priority greater than a predetermined threshold priority.

Example 14 includes the method of example 11 or some other example herein, wherein the priority condition is based on: a type of media access control (MAC) control element (CE) that triggers the SR transmission.

Example 15 includes the method of example 11 or some other example herein, wherein the priority condition is based on: a physical uplink control channel (PUCCH) configuration associated with the SR transmission.

Example 16 includes the method of example 11 or some other example herein, wherein the priority condition is based on SR configuration parameters.

Example 17 includes the method of example 9 or some other example herein, wherein the first PUSCH transmission occasion is associated with a hybrid automatic repeat request (HARQ) process identifier (PID) and the method further comprises: determining a CG timer associated with the HARQ PID is running; and determining, based on said determining the CG timer is running, the first PUSCH transmission occasion is not to be used by the UE for a PUSCH transmission.

Example 18 includes the method of example 9 or some other example herein, wherein said determining the first PUSCH transmission occasion is not to be used by the UE for a PUSCH transmission is performed by a media access control (MAC) entity of the UE; and the method further comprises: providing, by the MAC entity to the PHY entity, an indication that the first PUSCH transmission occasion is not to be used by the UE for a PUSCH transmission.

Example 19 includes a method to be implemented by a base station, the method comprising: generating a scheduling request (SR) configuration with an indication of whether a user equipment (UE) is to determine whether a configured grant (CG) physical uplink shared channel (PUSCH) resource is to be used prior to deprioritizing an SR transmission of an SR physical uplink control channel (PUCCH) resource; and transmitting the SR configuration to the UE.

Example 20 includes the method of example 19 or some other example herein, further comprising: generating a CG configuration to configures a plurality of CG PUSCH transmission occasions; and transmitting the CG configuration to the UE.

Example 21 includes a method comprising: processing a scheduling request-physical uplink control channel (SR-PUCCH) resource that overlaps with an uplink (UL)-shared channel (SCH) resource; determining whether the UL-SCH resource corresponds to an unused UL grant; and determining, based on said determining whether the UL-SCH resource corresponds to an unused UL grant, whether the SR-PUCCH resource is available for a scheduling request (SR) transmission.

Example 22 includes the method of example 21 or some other example herein, wherein: determining whether the UL-SCH resource corresponds to an unused UL grant includes determining the UL-SCH resource corresponds to an unused UL grant; and determining whether the SR-PUCCH resource is available for the SR transmission includes determining the SR-PUCCH resource is available for the SR transmission based on said determining the UL-SCH resource corresponds to the unused UL grant.

Example 23 includes the method of example 22 or some other example herein, further comprising: determining that a priority condition is met; prioritizing the SR transmission based on said determining that the priority condition is met; and determining the SR-PUCCH resource is available for the SR transmission based further on said prioritizing the SR transmission.

Example 24 includes the method of example 23 or some other example herein, wherein data of a logical channel (LCH) or logical channel group (LCG) triggers the SR transmission and the priority condition comprises: the LCH or LCG being associated with a priority greater than a predetermined threshold priority; or a data volume of the LCH or LCG being greater than a predetermined threshold volume.

Example 25 includes the method of example 23 or some other example herein, wherein data of a logical channel (LCH) or logical channel group (LCG) triggers the SR transmission and the priority condition comprises: a remaining time until discarding of the data of the LCH or LCG is less than a predetermined time threshold; or quality of service flow mapped to a data radio bearer associated with the LCH or LCG being associated with a priority greater than a predetermined threshold priority.

Example 26 includes the method of example 23 or some other example herein, wherein the priority condition is based on: a type of media access control (MAC) control element (CE) that triggers the SR transmission; a physical uplink control channel (PUCCH) configuration associated with the SR transmission; or SR configuration parameters.

Example 27 includes the method of example 21 or some other example herein, wherein: determining whether the UL-SCH resource corresponds to an unused UL grant includes determining the UL-SCH resource does not correspond to an unused UL grant; and determining whether the SR-PUCCH resource is available for the SR transmission includes determining the SR-PUCCH resource is not available for the SR transmission based on said determining the UL-SCH resource does not correspond to an unused UL grant.

Example 28 includes the method of example 21 or some other example herein, wherein the UL-SCH resource corresponds to a first PUSCH transmission occasion associated with a hybrid automatic repeat request (HARQ) process identifier (PID) and the method further comprises: determining a CG timer associated with the HARQ PID is running; and determining, based on said determining the CG timer is running, the UL-SCH resource corresponds to an unused UL grant.

Another example may include an apparatus comprising logic, modules, or circuitry to perform one or more elements of a method described in or related to any of examples 1-28 or any other method or process described herein.

Another example may include a method, technique, or process as described in or related to any of examples 1-28 or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-28, or portions thereof.

Another example includes a signal as described in or related to any of examples 1-28 or portions or parts thereof.

Another example may include a datagram, information element, packet, frame, segment, PDU, or message as described in or related to any of examples 1-28, or portions or parts thereof, or otherwise described in the present disclosure.

Another example may include a signal encoded with data as described in or related to any of examples 1-28, or portions or parts thereof, or otherwise described in the present disclosure.

Another example may include a signal encoded with a datagram, IE, packet, frame, segment, PDU, or message as described in or related to any of examples 1-28, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Another example may include a computer program comprising instructions, wherein execution of the program by a processing element is to cause the processing element to carry out the method, techniques, or process as described in or related to any of examples 1-28 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Any of the above-described examples may be combined with any other example (or combination of examples) unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a scheduling request-physical uplink control channel (SR-PUCCH) resource that overlaps with an uplink (UL)-shared channel (SCH) resource;
determining whether the UL-SCH resource corresponds to an unused UL grant; and
determining, based on said determining whether the UL-SCH resource corresponds to an unused UL grant, whether the SR-PUCCH resource is available for a scheduling request (SR) transmission.

2. The method of claim 1, wherein:
determining whether the UL-SCH resource corresponds to an unused UL grant includes determining the UL-SCH resource corresponds to an unused UL grant; and
determining whether the SR-PUCCH resource is available for the SR transmission includes determining the SR-PUCCH resource is available for the SR transmission based on said determining the UL-SCH resource corresponds to the unused UL grant.

3. The method of claim 2, further comprising:
determining that a priority condition is met;
prioritizing the SR transmission based on said determining that the priority condition is met; and
determining the SR-PUCCH resource is available for the SR transmission based further on said prioritizing the SR transmission.

4. The method of claim 3, wherein data of a logical channel (LCH) or logical channel group (LCG) triggers the SR transmission and the priority condition comprises:
the LCH or LCG being associated with a priority greater than a predetermined threshold priority; or
a data volume of the LCH or LCG being greater than a predetermined threshold volume.

5. The method of claim 3, wherein data of a logical channel (LCH) or logical channel group (LCG) triggers the SR transmission and the priority condition comprises:
a remaining time until discarding of the data of the LCH or LCG is less than a predetermined time threshold; or
quality of service flow mapped to a data radio bearer associated with the LCH or LCG being associated with a priority greater than a predetermined threshold priority.

6. The method of claim 3, wherein the priority condition is based on:
a type of media access control (MAC) control element (CE) that triggers the SR transmission;
a physical uplink control channel (PUCCH) configuration associated with the SR transmission; or
SR configuration parameters.

7. The method of claim 1, wherein:
determining whether the UL-SCH resource corresponds to an unused UL grant includes determining the UL-SCH resource does not correspond to an unused UL grant; and
determining whether the SR-PUCCH resource is available for the SR transmission includes determining the SR-PUCCH resource is not available for the SR transmission based on said determining the UL-SCH resource does not correspond to an unused UL grant.

8. The method of claim 1, wherein the UL-SCH resource corresponds to a first PUSCH transmission occasion associated with a hybrid automatic repeat request (HARQ) process identifier (PID) and the method further comprises:
determining a CG timer associated with the HARQ PID is running; and
determining, based on said determining the CG timer is running, the UL-SCH resource corresponds to an unused UL grant.

9. One or more non-transitory, computer-readable media having instructions that, when executed, cause processor circuitry to:
process a configured grant (CG) configuration that configures a plurality of physical uplink shared channel (PUSCH) transmission occasions;
determine a first PUSCH transmission occasion of the plurality of PUSCH transmission occasions is not to be used for a PUSCH transmission; and
prioritize, based on said determination that the first PUSCH transmission occasion is not to be used for a PUSCH transmission, a scheduling request (SR) transmission in an SR transmission occasion that overlaps with the first PUSCH transmission occasion.

10. The one or more non-transitory, computer-readable media of claim 9, wherein the instructions, when executed, further cause the processor circuitry to:
generate, based on said determination that the first PUSCH transmission occasion is not to be used for a PUSCH transmission, an unused transmission occasion (UTO) uplink control information (UCI) for transmission in a second PUSCH transmission occasion of the plurality of PUSCH transmission occasions.

11. The one or more non-transitory, computer-readable media of claim 9, wherein the instructions, when executed, further cause the processor circuitry to:
detect a priority condition associated with the SR transmission; and
prioritize the SR transmission based further on said detection of the priority condition.

12. The one or more non-transitory, computer-readable media of claim 11, wherein data of a logical channel (LCH) or logical channel group (LCG) triggers the SR transmission and the priority condition comprises:
the LCH or LCG being associated with a priority greater than a predetermined threshold priority; or
a data volume of the LCH or LCG being greater than a predetermined threshold volume.

13. The one or more non-transitory, computer-readable media of claim 11, wherein data of a logical channel (LCH) or logical channel group (LCG) triggers the SR transmission and the priority condition comprises:
a remaining time until discarding of the data of the LCH or LCG is less than a predetermined time threshold; or
quality of service flow mapped to a data radio bearer associated with the LCH or LCG being associated with a priority greater than a predetermined threshold priority.

14. The one or more non-transitory, computer-readable media of claim 11, wherein the priority condition is based on:
a type of media access control (MAC) control element (CE) that triggers the SR transmission.

15. The one or more non-transitory, computer-readable media of claim 11, wherein the priority condition is based on:
a physical uplink control channel (PUCCH) configuration associated with the SR transmission.

16. The one or more non-transitory, computer-readable media of claim 11, wherein the priority condition is based on SR configuration parameters.

17. The one or more non-transitory, computer-readable media of claim 9, wherein the first PUSCH transmission occasion is associated with a hybrid automatic repeat request (HARQ) process identifier (PID) and the instructions, when executed, further cause the processor circuitry to:
determine a CG timer associated with the HARQ PID is running; and
determine, based on said determination that the CG timer is running, the first PUSCH transmission occasion is not to be used for a PUSCH transmission.

18. The one or more non-transitory, computer-readable media of claim 9, wherein to determine the first PUSCH transmission occasion is not to be used for a PUSCH transmission is performed by a media access control (MAC) layer; and the instructions, when executed, further cause the processor circuitry to:
provide, by the MAC layer to a physical (PHY) layer, an indication that the first PUSCH transmission occasion is not to be used for a PUSCH transmission.

19. An apparatus comprising:
processor circuitry to:
generate a scheduling request (SR) configuration with an indication of whether a user equipment (UE) is to determine whether a configured grant (CG) physical uplink shared channel (PUSCH) resource is to be used prior to deprioritizing an SR transmission of an SR physical uplink control channel (PUCCH) resource; and
output the SR configuration for transmission to the UE; and
interface circuitry coupled with the processor circuitry to enable communication.

20. The apparatus of claim 19, wherein the processor circuitry is further to:
generate a CG configuration to configure a plurality of CG PUSCH transmission occasions; and
output the CG configuration for transmission to the UE.
